(19) United States
(12) Patent Application Publication
(10) Pub. No.: US 2013/0300225 A1
(43) Pub. Date: Nov. 14, 2013

(54) MOLDED MOTOR

(71) Applicants: Seiji Kurozumi, Osaka (JP); Keisaku Nakano, Osaka (JP); Masanori Morita, Osaka (JP)

(72) Inventors: Seiji Kurozumi, Osaka (JP); Keisaku Nakano, Osaka (JP); Masanori Morita, Osaka (JP)

(73) Assignee: PANASONIC CORPORATION, Kadoma-shi, Osaka (JP)

(21) Appl. No.: 13/981,518

(22) PCT Filed: Jan. 26, 2012
(86) PCT No.: PCT/JP2012/000482

§ 371 Date: Jul. 24, 2013

(30) Foreign Application Priority Data
Feb. 1, 2011 (JP) 2011-019477

(51) Int. Cl. H02K 1/12

(52) U.S. Cl. CPC H02K 1/12
USPC 310/43

(57) ABSTRACT

A molded motor of the present invention comprises: a stator having a stator core wound with a winding and molded with a molding resin; a rotor including a rotary body having a ferrite resin magnet which is a permanent magnet, disposed in a circumferential direction and confronting the stator, and a shaft penetrating through an axial center of the rotary body; a pair of bearings supporting the shaft; a pair of electrically-conductive brackets securing the bearings; and conductive pins which is connecting parts that electrically connect the pair of brackets. The rotor is provided with a first dielectric layer between the shaft and an outer peripheral surface of the rotary body, and a second dielectric layer between the shaft and the bearings.

### TECHNICAL FIELD

The present invention relates to a molded motor having a stator and a bracket molded integrally with a resin. In particular, the invention relates to an improved molded motor to suppress development of electrolytic corrosion in a bearing.

### BACKGROUND ART

A method of driving motors employed recently in a growing number is the inverter control that uses pulse width modulation method (hereinafter referred to as “PWM method”) because of the advantages of variable-speed performance and high efficiency of the motors.

When inverter control of the PWM method is used, however, an electric potential at a neutral point of a winding does not stay at 0 (zero) volt. As a result, a difference in the electric potential occurs between an outer ring and an inner ring of a bearing (hereinafter referred to as “shaft voltage”). The shaft voltage includes a high-frequency component attributable to switching operation. If the shaft voltage reaches a breakdown voltage of an oil film present in the bearing, a micro electric current flows inside the bearing. This flow of the micro electric current causes electrolytic corrosion in the bearing. When the electrolytic corrosion progresses, a phenomenon of wavy wear appears on the inner ring, the outer ring or balls of the bearing. The phenomenon of wavy wear makes the bearing liable to produce abnormal noise which becomes one of the main causes of troubles with the motor.

It is strongly demanded that motors used mainly for driving blowers of home appliances be low in noise and vibration. Molded motors of a type having a stator core and a winding molded integrally with a resin have become predominant in order to satisfy this demand. Some of the molded motors also have circuit boards and the like with electronic components mounted on them, which are placed inside the molded motors.

Any molded motor made with a resin as the molding material lacks the strength necessary to secure the bearings. The molded motor made with a resin as the molding material also lacks dimensional accuracy because it is the resin that forms the motor. The molded motor, if lacking the dimensional accuracy becomes liable to creep attributed to a slipping phenomenon between the bearings and a bracket due to a force produced in a radial direction by a transmitted load. To improve such troubles of the molded motor, it is a general practice to secure the bearings in advance by using a metal bracket processed from a steel sheet. The metal bracket can provide excellent dimensional accuracy.

On the other hand, a molded motor provided with a metal bracket has a stator insulated from the bracket. Impedance on the stator side increases, and a difference in voltage rises between an outer ring and an inner ring of the bearing when the stator is insulated from the bracket. In other words, the shaft voltage becomes higher. In addition, the molded motor provided with the metal bracket holds the stator and the bracket independent of each other. When the stator and the bracket are independent, the shaft voltage is liable to change easy depending on an external environment in which the motor is installed.

The electrolytic corrosion means a phenomenon that a material of the bearing becomes damaged due to arc discharges. The reason of this is due to a shaft current that flows through a path from the inner ring to balls and to the outer ring of the bearing arising from the shaft voltage produced between the inner ring and the outer ring of the bearing. The following measures are conceivable to suppress the electrolytic corrosion:
(1) to reduce the shaft voltage between the inner ring and the outer ring of the bearing; and
(2) to reduce the shaft current from the inner ring of the bearing to the balls and from the balls to the outer ring of the bearing.

One specific method of the above item (1) is to reduce the shaft voltage by electrically shorting a stator core to the metal bracket having electrical conductivity and changing an electrostatic capacitance between them (refer to patent literature 1, for example).

Another method, in a structural viewpoint of the molded motor, is a construction to establish an electrical continuity between the stator core and the metal bracket having electrical conductivity (refer to patent literature 2, for example).

A specific method of the above item (2) is to replace steel balls disposed inside of the bearing with non-conductive ceramic balls. This method has a very high effect of suppressing formation of electrolytic corrosion. However, it is difficult to adopt this method for general-purpose motors because of high costs.

There are other methods, in a case of sheet-steel motor having a metal frame and a metal bracket, such as coating an insulating material on any of interfacing portions from a rotor to a bearing and the bearing to the metal frame. Such a structure means that an electrostatic capacitance of the coating is connected in series to another electrostatic capacitance in the bearing. Hence the shaft voltage applied to the bearing can be reduced (refer to patent literature 3 for example).

Here, impedance is given by the relational expression of Z=1/jωC+R when an electrostatic capacitance and a resistance are connected in parallel, where Z, j, ω, C and R denote impedance, imaginary number, angular frequency, electrostatic capacitance and resistance, respectively. It is known from this expression that the impedance decreases with increase in capacitance and decrease in resistance. Or, the impedance increases with decrease in capacitance and increase in resistance, according to this expression.

In a conventional method such as that of patent literature 1, however, it is not possible to adjust the impedance since this method makes a short circuit between the stator core and the metal bracket having electrical conductivity. There arises a possibility that the shaft voltage increases depending on a material and a structure of the magnet used in the rotor.

In addition, the conventional method like that of patent literature 1 lowers the impedance. It therefore becomes necessary to maintain a balance between the inner ring and the outer ring of the bearing at all times under a condition of high electric potential. There are cases, however, that the balance of impedance comes undone due to an environment in which the motor is used, a variation in the accuracy resulting from assembling of the stator and the rotor, and the like reasons. In such cases, electrolytic corrosion is considered likely to occur because the shaft voltage becomes excessively high.

A conventional method such as the one shown in patent literature 3 is effective for a motor having small overall impedance like that of a sheet-steel motor. However, in the case of a motor having large overall impedance like the molded motor, electrolytic corrosion is likely to occur since it is unable to prevent the shaft current sufficiently. In addition, variations occur in manufacturing when a dielectric body is formed by coating. If variations occur in the manufacturing, they may increase variations in the impedance or cause the coating to come off the dielectric body during assembling.

PTL 1: Japanese Patent Unexamined Publication No. 2007-159302

PTL2: Japanese Patent No. 3775370

PTL3: Japanese Patent Unexamined Publication No. 2005-198374

### SUMMARY OF THE INVENTION

A molded motor of the present invention comprises a stator having a stator core wound with a winding and molded with a molding resin, a rotor including a rotary body having a permanent magnet disposed in a circumferential direction to confront the stator and a shaft penetrating through an axial center of the rotary body, a pair of bearings for supporting the shaft, a pair of electrically-conductive brackets for securing the bearings, and a connecting part that electrically connects the pair of brackets.

The rotor is provided with a first dielectric layer between the shaft and an outer peripheral surface of the rotary body, and a second dielectric layer between the shaft and the bearings.

In the rotor of low impedance, this provision of the first dielectric layer and the second dielectric layer makes it equivalent to a configuration having an electrostatic capacitance of the first dielectric layer and another electrostatic capacitance of the second dielectric layer connected in series. In other words, it is possible to increase impedance on the rotor side. With this increase, the impedance on the rotor side can be approximated to impedance on the stator side having a high value. As a result, these impedances can be balanced in a manner to equalize high-frequency electric potentials between an inner ring side and an outer ring side of the bearing.

### BRIEF DESCRIPTION OF THE DRAWINGS

FIG. 1 is a structural drawing showing a sectioned view of a brushless motor according to a first exemplary embodiment of the present invention.

FIG. 2 is a graphic chart showing a shaft voltage waveform of a brushless motor of embodied sample 1 according to the present invention.

FIG. 3 is another graphic chart showing a shaft voltage waveform of a brushless motor of reference sample 1.

### DETAILED DESCRIPTION OF THE PREFERRED EMBODIMENTS

Description will be provided hereinafter of a motor according to the present invention by referring to the accompanying drawings.

### First Exemplary Embodiment

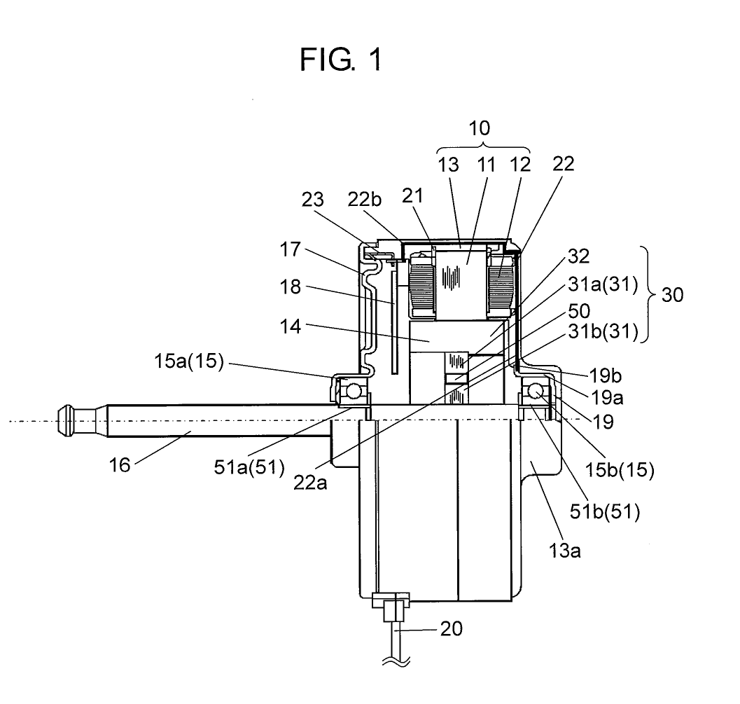

FIG. 1 is a structural drawing showing a sectioned view of a brushless motor according to the first exemplary embodiment of this invention. Description provided here is an example in which the brushless motor according to the first embodiment of this invention is used for a blower fan. This blower fan is adapted for mounting in an air conditioner or the like device representing an electric apparatus. In the first embodiment, the motor illustrated and described is an inner-rotor type motor having a rotor disposed rotatably to an inner peripheral side of a stator.

In FIG. 1, stator 10 has stator winding 12 wound around stator core 11, and molded with a molding resin designated as insulation resin 13. Stator core 11 has resin 21, which is an insulator for insulating stator core 11 from stator winding 12. Stator winding 12 is wound around stator core 11 through resin 21. Stator core 11 is molded together with other stationary members within insulation resin 13. These members are integrally molded with the molding resin, thus forming stator 10 of generally cylindrical in outer shape.

Rotor 14 is inserted in stator 10 with a gap between them. Rotor 14 includes rotary body 30 and shaft 16 that penetrates through an axial center of this rotary body 30. Rotary body 30 has ferrite resin magnet 32, which is a permanent magnet disposed in a circumferential direction in a manner to confront the inner peripheral side of stator 10. Rotary body 30 is a disc-like shape and includes rotor core 31. Description is provided in details by referring to FIG. 1. Rotary body 30 includes outer core 31a that constitutes an outer portion of rotor core 31, first dielectric layer 50, and inner core 31b that constitutes an inner portion of rotor core 31, which are arranged in this order from ferrite resin magnet 32 at the outermost side toward shaft 16 at the interior side. In other words, rotary body 30 in the first embodiment has rotor core 31, first dielectric layer 50 and ferrite resin magnet 32, which are integrally molded together. As illustrated, rotary body 30 is so disposed that its outer peripheral side confronts the inner peripheral side of stator 10.

A pair of bearings 15 support shaft 16. These two bearings 15 for supporting shaft 16 are mounted to shaft 16 of rotor 14. Bearings 15 are cylindrically-shaped bearings, each of which has a plurality of steel balls. An inner ring side of each bearing 15 is fixed to shaft 16. One end of shaft 16 protruding from a main body of the brushless motor is defined as an output-shaft side, and the other end is defined as an anti-output-shaft side. In FIG. 1, the output-shaft side of the shaft is shown on the left side, and the anti-output-shaft side is shown on the right side. Shaft 16 is supported by bearing 15a at the output-shaft side and bearing 15b at the anti-output-shaft side.

A pair of electrically conductive brackets 17 and 19 secure bearings 15 (i.e., 15a and 15b). The outer ring sides of bearings 15 are fixed to corresponding metal brackets 17 and 19. In FIG. 1, bearing 15a at the output-shaft side is fixed to bracket 17, and bearing 15b at the anti-output-shaft side is fixed to bracket 19.

Conductive pins 22 and 23 representing connecting parts electrically connect the pair of brackets 17 and 19. Conductive pin 22 is electrically connected to bracket 19 in advance, as shown in FIG. 1. End portion 22a of conductive pin 22 is connected to flange portion 19b of bracket 19. Conductive pin 22 is disposed within insulation resin 13. Conductive pin 22 is molded integrally with insulation resin 13 in the same manner as bracket 19. Conductive pin 22 is extended within insulation resin 13 from flange portion 19b toward the outer periphery of the brushless motor. Conductive pin 22 is bent at or near the outer periphery of the brushless motor in a direction generally in parallel to shaft 16, and conductive pin 22 is extended further toward the output-shaft side of shaft 16. Another end portion 22b of conductive pin 22 is exposed from an end surface on the output-shaft side of insulation resin 13. Conductive pin 23 is connected with end portion 22b. Conductive pin 23 is to make an electrical connection between conductive pin 22 and bracket 17. When bracket 17 is press-fitted to stator 10, conductive pin 23 comes into contact with bracket 17 to secure an electrical continuity of conductive pin 23 with bracket 17.

Rotor 14 is provided with first dielectric layer 50 and second dielectric layers 51 (i.e., 51a and 51b). First dielectric layer 50 is located between shaft 16 and the outer peripheral surface of rotary body 30. Second dielectric layer 51a is located between shaft 16 and bearing 15a. Second dielectric layer 51b is located between shaft 16 and another bearing 15b.

Since shaft 16 is supported by two bearings 15 in the above structure, rotor 14 is freely rotatable. Two brackets 17 and 19 are electrically connected through conductive pins 22 and 23. Brackets 17 and 19 are insulated from stator core 11 by insulation resin 13. When conductive pin 22 is disposed inside of the motor, i.e. within insulation resin 13, conductive pin 22 can be protected from corrosion, external forces, and the like. Thus, the reliability of the electric connections of two brackets 17 and 19 is improved against the effects of use environment, external stress, and the like.

Furthermore, first dielectric layer 50 and second dielectric layer 51 provided within rotor 14 of low impedance make the structure equivalent to a configuration having an electrostatic capacitance of first dielectric layer 50 and another electrostatic capacitance of second dielectric layer 51 connected in series. In other words, it is possible to increase impedance of the rotor 14 side. With this increase, the impedance of the rotor 14 side can be approximated to impedance of the stator 10 side having a high value. Accordingly, these impedances can be balanced in a manner to equalize high-frequency electric potentials between an inner ring side and an outer ring side of bearing 15.

As a result, the molded motor of the first embodiment of this invention can provide the following advantages. That is, the impedances of two brackets 17 and 19 generally become equal without a significant decrease. The impedance of rotor 14 side (i.e., the inner ring side of the bearing) increases. The impedance of rotor 14 side and the impedances of two brackets 17 and 19 on the stator 10 side (i.e., the outer ring side of the bearing) come to approximate to each other, thereby getting them balanced in the high frequency electric potentials between the inner ring side and the outer ring side of bearing 15. Hence provided is the motor in which electrolytic corrosion is prevented from being developed in bearing 15.

In addition, the brushless motor of the first embodiment is equipped internally with printed circuit board 18. This printed circuit board 18 has a drive circuit including a control circuit mounted on it. After printed circuit board 18 is built into the motor, bracket 17 is press-fitted to stator 10. The brushless motor is thus made up.

Printed circuit board 18 is connected with connecting wires 20. Connecting wires 20 includes lead wires for supplying printed circuit board 18 with power supply voltage Vdc for the winding, power supply voltage Vcc for the control circuit, and control voltage Vsp for controlling a rotation speed. Connecting wires 20 also include a grounding wire of the control circuit.

A zero potential point on printed circuit board 18 carrying the drive circuit is isolated from both the earth ground and a primary-side (power supply) circuit. The zero potential point therefore remains in a floating condition with respect to electric potentials of the earth ground and the primary-side (power supply) circuit. The zero potential point denotes a wiring conductor carrying an electric potential of 0 volt which becomes a reference potential on printed circuit board 18. The zero potential point generally refers to a grounding conductor, which is called earth ground. The grounding wire included in connecting wires 20 is connected to this zero potential point, that is, the grounding conductor.

A drive circuit is mounted on printed circuit board 18. A power supply circuit for supplying a power voltage to the winding connected with printed circuit board 18, a power supply circuit for supplying a power voltage to the control circuit, a lead wire for applying a control voltage, a grounding wire of the control circuit, and the like components are electrically isolated from all of a primary-side (power supply) circuit of the power supply circuit supplying the power voltage to the winding, a primary-side (power supply) circuit of the power supply circuit supplying the power voltage to the control circuit, an earth ground connected with these primary-side (power supply) circuits and an independently grounded earth ground. In other words, the drive circuit mounted on printed circuit board 18 is in a condition isolated electrically from the electric potential of the primary-side (power supply) circuits as well as the electric potential of the earth ground. The electric potential therefore stays in a floating condition. This condition is also expressed as a condition that the electric potential is floated, as is well-known. In addition, the power supply circuit supplying the power voltage to the winding connected with printed circuit board 18 and the power supply circuit supplying the power voltage to the control circuit are also called floating power supplies, which is also well-known.

Individual power supply voltages and a control signal are supplied to the brushless motor having the above structure through connecting wires 20. A drive current to be supplied to stator winding 12 is produced by the drive circuit mounted on printed circuit board 18 according to the individually supplied power supply voltages and the control signal. The drive current supplied to stator winding 12 generates a magnetic field from stator core 11. The magnetic field generated from stator core 11 and magnetic field produced from ferrite resin magnet 32 generate an attractive force and a repulsive force depending on polarities of these magnetic fields. Rotor 14 rotates about shaft 16 by the effect of these attractive and repulsive forces.

Furthermore, the molded motor of the first embodiment has larger impedance between shaft 16 and bearing 15 than that between shaft 16 and the outer peripheral surface of rotary body 30. In other words, the impedance of the stator 10 side and the impedance of the rotor 14 side are at high levels. Therefore, electric potentials of both the inner ring side and the outer ring side of bearing 15 are balanced at low levels. As a result, it becomes possible to reduce the shaft voltage and prevent the shaft current from flowing without being influenced by the environment, etc. in which the molded motor is used.

Moreover, in the molded motor of the first embodiment, at least one of first dielectric layer 50 and second dielectric layer 51 is constructed of a molded form of a dielectric resin. First dielectric layer 50 is disposed between shaft 16 and the outer peripheral surface of rotary body 30. Second dielectric layer 51 is disposed between shaft 16 and bearings 15 which support shaft 16. Rotary body 30 constructed in this manner achieves a structure that can be manufactured easily and steadily, thereby improving the productivity of rotor 14 having the impedance increased on the rotor 14 side.

Next, description is provided in more detail about the brushless motor according to the first embodiment of this invention.

The brushless motor has shaft 16 supported by two bearings 15, as described above. Each of bearings 15 is fixed to and supported by brackets 17 and 19. In this first embodiment, each of bearings 15 is so composed as to be fixed by metal brackets having electrical conductivity in order avoid a failure due to creep. That is, the electrically conductive brackets of excellent dimensional accuracy are fabricated in advance with a sheet steel and used to fix bearings 15. It is especially preferable to provide such a structure when a high power is required from the motor.

Specifically, bracket 19 of an outer diameter generally equal to that of bearing 15b is used to fix bearing 15b on the anti-output-shaft side. This bracket 19 is molded integrally with insulation resin 13. A shape of insulation resin 13 on the anti-output-shaft side is so formed as to have main protrusion 13a that protrudes in a direction of the anti-output shaft from a main body of the brushless motor, as shown in FIG. 1. Bracket 19 is disposed to an interior side of the main part of this main protrusion 13a, as an inner bracket. Bracket 19 is molded integrally with insulation resin 13. Bracket 19 has a cup-like shape that forms a hollow cylindrical geometry. More specifically, bracket 19 has cylindrical portion 19a and flange portion 19b, and one side of cylindrical portion 19a is opened. Flange portion 19b has a ring-like shape that extends only by a small extent toward the outer circumference from the opened edge of cylindrical portion 19a. An inner diameter of cylindrical portion 19a is nearly equal to an outer diameter of bearing 15b. When bearing 15b is press-fitted into cylindrical portion 19a, bearing 15b is rigidly secured to insulation resin 13 via bracket 19. Because of this structure, in which the outer ring side of bearing 15b is fixed to metal bracket 19, the brushless motor can avoid any failure attributed to creep.

An outer diameter of flange portion 19b is slightly larger than the outer diameter of bearing 15b. In other words, the outer diameter of flange portion 19b is so formed as to be larger than the outer diameter of bearing 15b, and at least smaller than an outer diameter of rotary body 30. Bracket 19 formed into this shape can reduce an amount of usage of the costly metallic material as compared to flange portion 19b of such a structure, for instance, that it extends beyond the outer circumference of rotary body 30 toward stator 10. In addition, an outer shell of bracket 19, of which a surface area is reduced, can be molded integrally in such a manner that it is covered with insulation resin 13. As a result, the noise arising from bearing 15b can be suppressed.

Bearing 15a on the output-shaft side is fixed to the main body of the brushless motor with bracket 17. An outer diameter of bracket 17 is generally equal to that of stator 10. Bracket 17 of a plate-like form is generally circular in shape. Bracket 17 has a protruding portion of a diameter nearly equal to an outer diameter of bearing 15a in a center portion of the circular plate. An interior side of this protruding portion is hollow. Bearing 15a is press-fitted into the interior side of the above-mentioned protruding portion provided on bracket 17, after printed circuit board 18 is disposed in the vicinity of stator 10. Bracket 17 is press-fitted to stator 10 in such a manner that a connector terminal attached to an outer periphery of bracket 17 and another connector terminal on stator 10 engage with each other.

The brushless motor in this embodiment of the invention is completed as a result of the above structure. An assembling process can be simplified according to the brushless motor in this embodiment of the invention. Moreover, failures attributed to creep can be prevented according to this brushless motor since the outer ring side of bearing 15a is fixed to metal bracket 17.

### Embodied Sample 1

FIG. 1 shows a specific brushless motor pertaining to the structure illustrated above. This brushless motor has the following structure. Rotor 14 includes rotary body 30 and shaft 16 penetrating through the axial center of this rotary body 30. Rotor 14 is also provided with first dielectric layer 50 and second dielectric layers 50 (51a and 51b). First dielectric layer 50 is located between shaft 16 and an outer peripheral surface of rotary body 30. PBT resin is used for first dielectric layer 50. First dielectric layer 50 has a resin thickness of 2.5 mm. Each of second dielectric layers 51 (51a and 51b) is located between shaft 16 and corresponding one of bearings 15 (15a and 15b) that support shaft 16. An epoxy resin is used for second dielectric layers 51. Each of second dielectric layers 51 has a resin thickness of 0.5 mm. The brushless motor is constructed by assembling such rotor 14 and the resin-molded stator. By using the brushless motor of such a structure, a shaft voltage has been measured.

Bearings 15 used are type 608, which are ball bearings specified in the Japanese Industrial Standard (“JIS”). The ball bearings have 8 mm in inner diameter, 22 mm in outer diameter and 7 mm in width. Grease used is 240 in consistency. In the measurement of shaft voltages, a same stator has been used for both embodied sample 1 and reference sample 1. That is, when measuring the shaft voltage, a stator described in embodied sample 1 was exchanged with a rotor described in reference sample 1, as will be detailed later. Lubricant oil insulates an inner ring from an outer ring of bearing 15 when bearing 15 rotates.

The brushless motor is controlled by a PWM drive that generates a driving waveform from a carrier of high frequency. An induced voltage originated from the high frequency career is generated in brackets 17 and 19, and shaft 16 of this brushless motor. This induced voltage can be observed when the insulation of bearing 15 is maintained. On the other hand, arc discharges occur between the inner ring and the outer ring of bearing 15 if the insulation of bearing 15 cannot be maintained, which results in electrolytic corrosion. In other words, it can be known that a short path has occurred between the inner ring and the outer ring of bearing 15 when no induced voltage is observed.

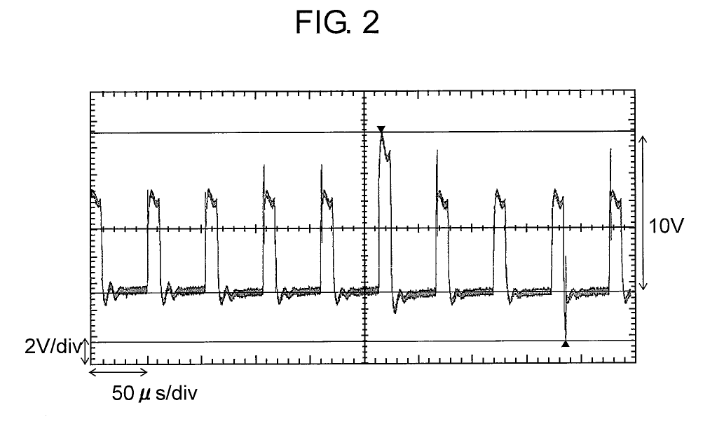

FIG. 2 shows a waveform of the shaft voltage in the brushless motor provided with the stator described in the embodied sample 1. It has been confirmed from this waveform of the shaft voltage that there has been no disorder in the career voltage waveform, which becomes a reference of the PWM drive, and that no shaft current has flowed. It is hence known that the insulation is maintained in the bearings.

### Reference Sample 1

A rotor used in reference sample 1 has same external dimensions as those of the rotor used in embodied sample 1. In the rotor used in reference sample 1, outer core 31a is not insulated from inner core 31b. A shaft is not insulated from bearings that support the shaft. Both the shaft and the bearings used in reference sample 1 have same external dimensions as those of the shaft and the bearings used in embodied sample 1. The brushless motor used as reference sample 1 is provided with the rotor, shaft and bearings of such structures. The brushless motor used as reference sample 1 has been evaluated according to a similar method as the brushless motor used as embodied sample 1.

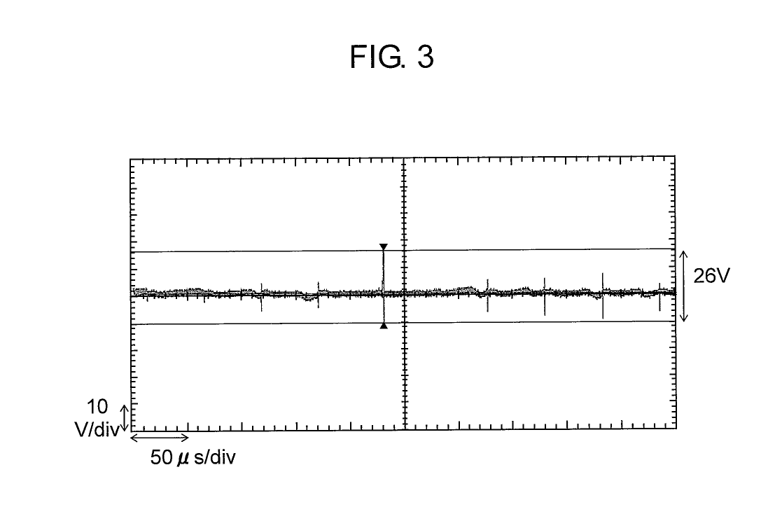

FIG. 3 shows a waveform of the shaft voltage in the brushless motor described in the reference sample 1. It has been confirmed from this waveform of the shaft voltage that there has been disorder in the career voltage waveform, which becomes a reference of the PWM drive, and that a shaft current has flowed. It is hence known that the insulation has not been maintained in the bearings.

As described above, the molded motor according to the first exemplary embodiment of the present invention comprises a stator having a stator core wound with a winding which is molded with a molding resin, a rotor including a rotary body having a permanent magnet disposed in a circumferential direction to confront the stator and a shaft penetrating through an axial center of the rotary body, a pair of bearings for supporting the shaft, a pair of electrically-conductive brackets for securing the bearings, and a connecting part that electrically connects the pair of brackets.

The rotor is provided with a first dielectric layer between the shaft and an outer peripheral surface of the rotary body, and a second dielectric layer between the shaft and the bearings.

It becomes possible by virtue of the first dielectric layer provided between the shaft and the outer peripheral surface of the rotary body that impedance on the rotor side can be increased. When the impedance of the rotor is increased, their balance can be maintained in a manner to equalize high-frequency electric potentials between an inner ring side and an outer ring side of the bearing. In addition, impedance between the shaft and bearing is higher than that between the shaft and the stator core within the stator. It is therefore unlikely for the motor to receive any influence even when impedance of a load coupled to the output side of the shaft changes. Furthermore, the molded motor provided here can prevent electrolytic corrosion from being developed in the bearing even when any change occurs in an external load on the brushless motor or in the environment where the brushless motor is used. The molded motor according to the first exemplary embodiment of this invention, when built into an electric apparatus, can provide the electric apparatus with the molded motor featuring protection from development of electrolytic corrosion in the bearings.

### INDUSTRIAL APPLICABILITY

The motor of the present invention decreases a shaft voltage, and prevents development of electrolytic corrosion in bearings. It is therefore effective for motors to be mounted to electrical apparatuses, of which cost-cutting and long serviceable life is primarily desired. Indoor units and outdoor units of air conditioners, water heaters and air cleaners are some examples of the main electrical apparatuses.

### REFERENCE MARKS IN THE DRAWINGS

10 Stator

11 Stator core

12 Stator winding

13 Insulation resin

13a Main protrusion

14 Rotor

15, 15a, 15b Bearing

16 Shaft

17 Bracket (output-shaft side)

18 Printed circuit board

19 Bracket (anti-output-shaft side)

19a Cylindrical portion

19b Flange portion

20 Connecting wire

21 Resin (insulator)

22 Conductive pin (bracket side or anti-output-shaft side)

22a, 22b End portion

23 Conductive pin (bracket side or output-shaft side)

30 Rotary body

31 Rotor core

31a Outer core

31b Inner core

32 Ferrite resin magnet (permanent magnet)

50 First dielectric layer

51, 51a, 51b Second dielectric layer

1. A molded motor comprising:
a stator having a stator core wound with a winding and molded with a molding resin;
a rotor including a rotary body having a permanent magnet disposed in a circumferential direction and confronting the stator, and a shaft penetrating through
an axial center of the rotary body;
a pair of bearings for supporting the shaft;
a pair of electrically-conductive brackets for securing the bearings; and
a connecting part that electrically connects the pair of brackets,
wherein the rotor is provided with a first dielectric layer between the shaft and an outer peripheral surface of the rotary body, and a second dielectric layer between the shaft and the bearings.

2. The molded motor of claim 1, wherein impedance between the shaft and the bearings is set larger than impedance between the shaft and the outer peripheral surface of the rotary body.

3. The molded motor of claim 1, wherein at least one of the first dielectric layer and the second dielectric layer is a dielectric body formed of a resin.

4. The molded motor of claim 2, wherein at least one of the first dielectric layer and the second dielectric layer is a dielectric body formed of a resin.
